(19) United States
(12) Patent Application Publication
(10) Pub. No.: US 2003/0140426 A1
(43) Pub. Date: Jul. 31, 2003

(54) Dry cleaning business model algorithm

(76) Inventors: Wolf-Dieter R. Berndt, Reno, NV (US); Ronnell R. Runyon, Sacramento, CA (US)

Correspondence Address: Herbert C. Schulze, 2790 Wrondel Way, PMB 36, Reno, NV, 89502, US

(21) Appl. No.: 10/059,464

(22) Filed: Jan. 28, 2002

(51) Int. Cl. C11D 1/00; D06Q 1/02

(52) U.S. Cl. 8/142; 510/285

(57) ABSTRACT

This is a business model algorithm for a dry cleaning system utilizing organo silicone-based solvents and incorporating a business model algorithm for the conversion of dry cleaning equipment and machines which were previously designed for and used with other solvents. The algorithms include distinct studies of each individual machine or piece of equipment being converted and the application of particular techniques to accommodate the differences in the solvents including the plumbing of the machines, the safety factors involved, and special training and instruction of the equipment operating personnel.

### CROSS REFERENCE TO RELATED PATENT APPLICATIONS

This patent application is related to application Ser. No. ______, filed ______, of which applicant Ronnell R. Runyon is the inventor.

### BACKGROUND OF THE INVENTION

I. Field of the Invention

This invention is in the general field of cleaning methods and apparatus.

The invention is more particularly in the field of dry cleaning of fabrics, clothing, draperies, bedding and the like.

The invention is most particularly, but not exclusively, directed to the field of a dry cleaning business model algorithm utilizing, among other things, unique algorithm steps involving the conversion and utilization of equipment previously used in dry cleaning with perchloroethylene (commonly, and herein, referred to as “PERC”), petroleum based (herein “Pet”), and other solvents to the use of an organo silicone-based solvent or the like hereafter “sil-solve”.

II. Description of the Prior Art

The prior art pertaining to use of sil-solve and the like is disclosed in U.S. Pat. No. 5,942,007; U.S. Pat. No. 6,042,618; U.S. Pat. No. 6,056,789; U.S. Pat. No. 6,059,845; U.S. Pat. No. 6,063,135; and U.S. Pat. No. 6,086,635 and the file wrappers of those inventions and patents. Applicant Wolf-Dieter R. Berndt is a co-inventor of each of those inventions and patents.

In various jurisdictions there are laws related to the use of Perc, Pet, and other dry cleaning solvents. These laws are in a state of flux and new restrictions and requirements are being, or will be, imposed. Many of the requirements cannot be complied with by Perc, Pet, and other solvents. The use of sil-solve solvents and the like in dry cleaning complies with present and proposed restrictions on dry cleaning operations.

A weakness in the immediate utilization of sil-solves and the like in the dry cleaning industry is the cost of new equipment. Dry cleaning plants using Perc or Pet and other solvents have major investments in equipment. Such equipment in its normal condition is not suitable to use sil-solves, or the like. There is a present great need for a way to utilize existing Perc, Pet, and other dry cleaning equipment and machines with sil-solves. We have studied this problem and have found no means, nor method, to utilize existing Perc or Pet or other dry cleaning equipment with sil-solves before our present invention.

We have examined commercial sources, literature, and patents and have concluded there is no practical prior art addressing this subject.

### SUMMARY OF THE INVENTION

As stated above there has been a great need for a practical way in which to utilize existing Perc, Pet and other solvents dry cleaning equipment with sil-solves. We have now conceived and developed a complete business model algorithm which accomplishes the desired objectives.

Briefly, our invention consists of establishing an initial check list of operations and solvents on hand in an existing Perc or Pet or other dry cleaning establishments; supplying sil-solve necessary for flushing the equipment and for initial operation; inspecting and replacing as necessary all seals, gaskets and the like; installing special filters; water separators; temperature sensors; relative humidity sensors; steam valves and injector nozzles; programming, instruction, and testing as will be detailed below. During modification of the equipment we have also included redundant safety measures.

It is an object of this invention to provide a means and method to convert dry cleaning equipment using Perc, Pet, and other solvents to sil-solve solvents;

Another object of this invention is to provide for redundant safety features to insure accident free operation of dry cleaning establishments;

Another object of this invention is to enable existing dry cleaner establishments to comply with existing and new laws regarding emissions and the like with a minimum investment in new and converted equipment;

The foregoing and other objects and advantages of this invention will become apparent to those skilled in the art upon reading the description of a preferred embodiment, which follows, in conjunction with a review of the appended drawings.

### BRIEF DESCRIPTION OF THE DRAWINGS

FIG. 1 is a block diagram of steps of a complete dry cleaning business model algorithm; and

FIG. 2 is a block diagram of steps involved in a business model algorithm for actual conversion of customary dry cleaning equipment using Perc, Pet, or other non-sil-solve solvents into equipment suitable for use with sil-solve solvents or the like.

### DESCRIPTION OF A PREFERRED EMBODIMENT

An inventory of items bearing reference numerals on the drawings is:

| Numeral | Item |
|---|---|
| 10 | material to be dry cleaned is received and inspected |
| 10a | material to be dry cleaned is placed in converted equipment |
| 10b | material (now cleaned) is removed from converted equipment |
| 10e | material is inspected and treated |
| 10d | material returned to customer |
| 100 | license to use sil-solve |
| 101 | obtain information regarding existing equipment |
| 102 | order for sil-solve and waste containers |
| 103 | pre-installation procedures |
| 104 | preparation of equipment for conversion |
| 105 | install filter assembly and filters |
| 106 | install water separator |
| 107 | install redundant temperature sensors |
| 108 | install relative humidity sensor |
| 109 | install steam valve and injection nozzle |
| 110 | instruction re: programming |
| 111 | perform test cycles |
| 112 | machine placed in regular service |
| 113 | regular maintenance performed |

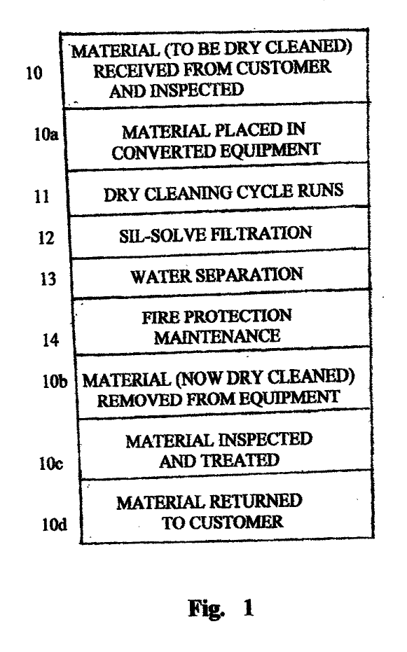

A complete dry cleaning cycle utilizing dry cleaning equipment converted from Perc, Pet, or the like to sil-solve is illustrated in FIG. 1. Material 10 to be dry cleaned is received from a customer at the dry cleaning establishment where the converted equipment is located. The material is inspected in a manner known to those skilled in the art. Foreign objects such as coins or the like located pockets, or otherwise mixed with the material to be cleaned are removed. The material is inspected to ascertain that it is suitable to be dry cleaned. The material found to be suitable for dry cleaning 10a is placed into the converted equipment 100. The dry cleaning cycle now runs with the sil-solve solvent being in contact with the material being cleaned and with sil-solve filtration through filtration systems and water removal by a gravity water separator supplemented by any existing water separator found in some existing Perc and Pet machines and the like. Further details of some actual cleaning procedures and qualities of certain sil-solve solvents and the like are found in the patents listed above of which co-applicant Wolf-Dieter R. Berndt is a co-inventor.

In various places in this specification and in the claims we may make reference to “customer”, “cleaning facility”, and certain similar expressions. It is to be understood that some dry cleaning facilities may be an integral part of a larger organization such as a large hotel, hospital, military base, or the like. The customer may be the hotel or hospital or base, itself. This invention is meant to include those organizations or departments within the terms “dry cleaning facility”, “customer” and the like. Likewise, dry cleaning material may be left at an outlying station by a customer and delivered from the outlying station to the dry cleaning facility. Common sense will lead a reader of this specification to understand that delivery to such an outlying station would be the equivalent of delivery to the cleaning facility, and the like.

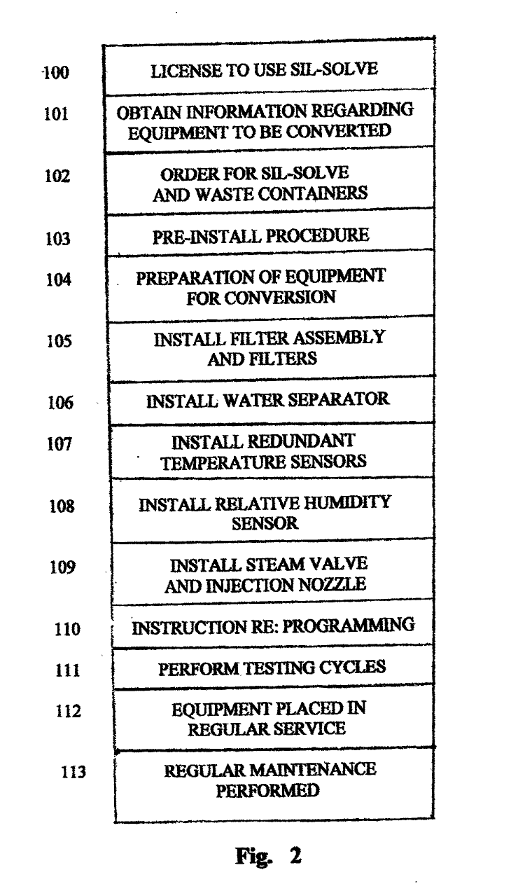

FIG. 2 is a block diagram of a novel, unique, and useful process of converting existing Perc and Pet dry cleaning equipment and the like to enable such machines to operate with the more desirable sil-solves. In making a conversion it has been found most desirable to use the algorithm I have developed, the steps of which are shown in FIG. 2.

101 Initially it is necessary for a dry cleaning facility to obtain a license to use the particular sil-solve solution known as SB-32 which has been developed by and is controlled by Green Earth Cleaning, LLC.

102 Upon receiving the license must provide, or have available for inspection, the following:

1) Business name

2) Address

3) Contact person

4) Message Contact means: home and business Phone, Fax, & email

5) Size and age of dry cleaning machine

6) Machine make and model number

7) Filter type

8) Filter quantity

9) Machine manual

10) Electrical schematic diagrams

11) Name and contact information of maintenance personnel

12) Current working order of machine

13) Name and contact information for current soap supplier

14) Availability of waste drums supplied by hazardous material waste hauler

15) Name and contact information for local fire marshal

16) Quantity of Perc or Pet or the like on hand

103 The facility is notified of the amount of sil-solve to order and the number of waste drums to provide for disposal of waste solvent.

104 The following pre-installation procedures will be performed:

1) Copy of machine manual and electrical diagrams are reviewed

2) Availability of machine gaskets (mainly tanks) is assured

3) Sufficient sil-solve on hand is confirmed

4) Filtration package is obtained

5) Water Separator is obtained

6) Redundant thermal sensing (fire protection) system is confirmed

7) Relative humidity sensor confirmed

8) Steam valve and injection nozzle confirmed

105 Preparation of equipment for conversion

1) All Perc, Pet, or the like is removed and placed in waste drums

2) Flush the machine's plumbing, tanks and pump with sil-solve and additives to remove any residue from old Perc, Pet or the like

3) Inspect all seals and gaskets and replace or repair as required

106 Install filter assembly and filters

107 Install water separator

108 Install redundant temperature sensors

109 Install relative humidity sensor

110 Install steam valve and injection nozzle to machine drum heated air intake

111 Instruct machine operator(s) regarding programming machine for optimum cleaning cycles and regarding maintenance operations and schedules

112 Run multiple test cleaning cycles to ensure that cycles are uniform and machine perform with consistent results

113 Place machine in regular service

114 Review initial maintenance activities

In making the conversion there are a number of unexpected advantages to operations with the converted equipment. First, it has been discovered that most animal fatty acids are not truly soluble in the sil-solves, and these fatty acids tend to form fatty micelles carried by the sil-solves. These fatty micelles are readily adsorbed from the sil-solve solution into a composition of paper, and/or carbon, and/or clay, or the like. However, the sil-solve solution will be absorbed by many clay products. Therefore we use a non-absorptive paper and/or clay composition or the like for filtration in the conversion of equipment involved in this invention. In the non-converted state of the equipment, the fatty acids are fully soluble in the various Perc, Pet and the like solutions. This results in the necessity of distillation of those solvents in order to recover them. Thus there is a major saving of time and money in the operation of the converted equipment in not requiring distillation, but merely simple filtration.

The sil-solves are generally class III-A solvents having flashpoints between 140° and 200° F. Because Perc and some other solvents are-non flammable there may be no safety devices on the machines. In converting, we use redundant thermal sensors (in the event one should fail). The thermal sensors trigger relays which shut off power to the equipment prior to the flashpoint of the sil-solve being used being reached.

During the dry cleaning and drying of fabrics and the like steam is sprayed onto and into the articles being agitated in the dry cleaning equipment. This results in some water entering and mixing with the cleaning fluid. The densities of the water and the sil-solve may be very nearly, but not identically, the same. Therefore, we have found that we can use a gravity separator with the lighter fluid being drawn off the top by suction as will be understood by those skilled in the art.

Since there are a variety of different dry cleaning machines in use, each machine, and the diagrams and literature, are carefully analyzed during conversion. We isolate or disengage existing filters and stills through their plumbing connections or by injecting foams or the like into certain plumbing connections.

As described and shown on the figures, this conversion process is universal and will satisfactorily convert virtually any dry cleaning equipment or machine so that such equipment or machine can operate with sil-solves at a small fraction of the cost of new equipment specifically designed for use with sil-solves.

In the claims which follow if we should fail to claim a patentable feature of my invention, such failure to claim will be due to inadvertence and is not to be interpreted as an intent to abandon or dedicate such feature.

While the embodiments of this invention specifically described and illustrated are fully capable of achieving the objects and advantages desired, it is to be understood that such embodiments have been shown and described for purposes of illustration only and not for purposes of limitation.

We claim:

1. The dry cleaning business model algorithm comprising the steps of: A dry cleaning facility receives from a customer, and inspects, material to be dry cleaned; the material suitable for dry cleaning is placed into dry cleaning equipment which has been converted from use with a non-silicone based cleaning solvent to use with a silicone based cleaning solvent; the equipment is run through a cleaning cycle which includes contact of the material being cleansed with silicone based solvent, filtration of the silicone based cleaning solvent while the cleaning cycle runs, and separation of water from the silicone based solvent while the cleaning cycle runs; at the conclusion of the cleaning cycle the material which has been in the converted dry cleaning equipment is removed and treated as necessary (lint removal, pressing, etc. as will be known to those skilled in the art; and, finally the now dry cleaned material is returned to the customer.

2. The dry cleaning equipment conversion from perc or pet solvents to the use of sil-solve solvents business model algorithm comprising the steps of: preparation of equipment for conversion; installation and connection of filter assembly and filters in association with the equipment; installation of water separator in association with the equipment; installation of temperature sensor in association with the equipment; and installation of steam valve.
